(19) United States
(12) Patent Application Publication
(10) Pub. No.: US 2021/0080593 A1
(43) Pub. Date: Mar. 18, 2021

(54) Global Navigation Satellite System Interferometric Reflectometry Signature-Based Defense

(71) Applicant: US Gov't represented by Secretary of the Air Force, Wright-Patterson AFB, OH (US)

(72) Inventor: Steven Lewis, Colorado Springs, CO (US)

(21) Appl. No.: 16/775,818

(22) Filed: Jan. 29, 2020

Related U.S. Application Data
(60) Provisional application No. 62/802,366, filed on Feb. 7, 2019.
(60) Provisional application No. 62/945,279, filed on Dec. 9, 2019.

(51) Int. Cl. G01S 19/21; G01S 19/22

(52) U.S. Cl. CPC G01S 19/215; G01S 19/22

(57) ABSTRACT

A transceiver system and methodology generates, monitors and detects changes in Global Navigation Satellite System (GNSS) interferometric reflectometry signatures as to provide defensive security for GNSS signals used for positioning, navigating, and timing applications.

### CROSS-REFERENCE TO RELATED APPLICATIONS

This application claims the benefit of priority under 35 U.S.C. § 119(e) to U.S. Provisional Applications: (i) Ser. No. 62/802,366 [Docket AFD-1921P] filed 7 Feb. 2019; and (ii) Ser. No. 62/945,279 [Docket AFD-1921P2] filed 9 Dec. 2019, both entitled “Global Navigation Satellite System Interferometric Reflectometry Signature-based Defense,” the contents of both of which are incorporated herein by reference in their entirety.

### ORIGIN OF THE INVENTION

The invention described herein was made by employees of the United States Government and may be manufactured and used by or for the Government of the United States of America for governmental purposes without the payment of any royalties thereon or therefore.

### BACKGROUND

### 1. Technical Field

This invention relates generally to Global Navigation Satellite System (GNSS) security and more specifically the detection, characterization and alerting of unintentional or intentional attacks on GNSS receivers using radio frequency interference (i.e. RFI, jamming) and spoofing.

### 2. Description of the Related Art

GNSS signals are vulnerable to RFI and spoofing. There are several documented GNSS RFI and spoofing detection methods [1]. RFI detection has become trivial with many detection algorithms available and built into GNSS receivers. This is not the case with spoofing. GNSS spoofing involves altering one of more components of the GNSS satellite transmissions: RF carrier, pseudorandom noise direct sequence spread spectrum code, and/or broadcast navigation message. Like jamming, generating spoofed GNSS signals is becoming easier and can have disastrous effects on people and systems, such as critical infrastructure, that rely on GNSS for positioning, navigation and timing (PNT).

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A illustrates signal-to-noise ratio (SNR), carrier phase, and code plots as a function of elevation for simulated impacts of multipath and line-of-sight signals for fixed Global Navigation Satellite System (GNSS) receivers at 2 m above a flat, specular reflective point;

FIG. 1B illustrates signal-to-noise ratio (SNR), carrier phase, and code plots as a function of elevation for simulated impacts of multipath and line-of-sight signals for fixed GNSS receivers at 5 m above a flat, specular reflective point;

FIG. 2 is a diagram illustrating GNSS interferometric reflectometry for spoofing detection;

FIG. 3A is a photograph of Socorro, N. Mex. reference station antenna looking south;

FIG. 3B is a photograph of Denton, Tex. reference station antenna looking north;

FIG. 4A is a graphical plot of GNSS-IR Signatures of GPS L1 transmission as measure by SCO1 Reference Stations in Socorro, N. Mex.;

FIG. 4B is a graphical plot of GNSS-IR Signatures of GPS L1 transmission as measure by TXDE Reference Stations in Denton, Tex.;

FIG. 5A is a graphical plot of two-hour hour, truncated GNSS-IR Signatures at a fixed reference station (SC01) in 2018 on J-Day 170;

FIG. 5B is a graphical plot of two-hour hour, truncated GNSS-IR Signatures at a fixed reference station (SCO1) in 2018 on J-Day 171;

FIG. 6 is a diagram of example dual antenna or receiver configuration on a building;

FIG. 7 is a graphical plot of six-hour GNSS-IR signature showing collect, convert, and remove steps;

FIG. 8 is a user interface depiction of a GNSS-IR signature monitoring tool for GPS satellites;

FIG. 9 is a conceptual diagram of GNSS-IR signature detection implementation;

FIG. 10 is a graphical plot of GNSS-IR signature from GPS PRN-17 at FAA CORS in Longmont, Colo.;

FIG. 11 is a graphical plot of GNSS-IR signature from GPS WAAS-138 at 44 degrees local elevation at FAA CORS in Longmont, Colo.;

FIG. 12 is a simplified diagram of a GNS-IR signature-based defense receiver, according to one or more embodiments;

FIG. 13 is a block diagram of a GNS-IR signature-based defense receiver with a single antenna, according to one or more embodiments;

FIG. 14 is a block diagram of a GNS-IR signature-based defense receiver with dual antennas, according to one or more embodiments;

FIG. 15 is a three-dimensional view of a building have dual mast antennas mounted for GNS-IR signature-based defense receiving; and

FIG. 16 is a flow diagram illustrating a method of GNSS spoofing detection using GNSS-IR signatures, according to one or more embodiments.

### DETAILED DESCRIPTION

According to aspects of the present innovation, a method is disclosed for authenticating a global navigation satellite system (GNSS) signal. In one or more embodiments, the method includes receiving, by a fixed, stationary GNSS receiver at a geographic location, a first broadcast from a particular GNSS satellite during a particular earth orbit. The method includes determining identifying information for the particular GNSS satellite according to GNSS satellite communication protocols. The method includes measuring line of sight and reflected signal strengths of the first broadcast of the particular GNSS satellite during a portion of the particular earth orbit to detect multipath variations that are characteristic for the geographic location. The method includes creating a GNSS interferometric reflectometry (IR) signatures associated with the particular GNSS satellite based on the measured broadcast. The method includes during a subsequent earth orbit, determining whether a second broadcast self-identified as being from the particular GNSS satellite matches the GNSS IR signature associated with the particular GNSS satellite. In response to determining that the second broadcast matches the GNSS IR signature, the method includes updating the GNSS IR signature at least in part using the second broadcast. In response to determining that the second broadcast does not match the GNSS IR signature, the method includes generating an alert indicating spoofing of the particular GNSS satellite.

According to aspects of the present innovation, a GNSS IR signature-based defense system includes a first GNSS antenna mounted on a first antenna mast at a geographic location. The GNSS IR signature-based defense system includes a first GNSS receiver that is communicatively coupled to the at least one GNSS antenna. The GNSS IR signature-based defense system includes a memory containing: (i) a positioning, navigation and timing (PNT) module; and (ii) a GNSS-IR signature-based defense module. The GNSS IR signature-based defense system includes a controller that is communicatively coupled to the first receiver and the memory. The controller executes the PNT module and the GNSS-IR signature-based defense module to enable the GNSS-IR signature based defense system to have the following functionality:

(i) receive, by the GNSS receiver, a first broadcast from a particular GNSS satellite during a particular earth orbit;

(ii) determine identifying information for the particular GNSS satellite according to GNSS satellite communication protocols;

(iii) measure line of sight and reflected signal strengths of the first broadcast of the particular GNSS satellite during a portion of the particular earth orbit to detect multipath variations that are characteristic for the geographic location;

(iv) create a GNSS IR signatures associated with the particular GNSS satellite based on the measured broadcast;

(v) store the GNSS-IR signature in the memory;

(vi) during a subsequent earth orbit, determine whether a second broadcast self-identified as being from the particular GNSS satellite matches the GNSS IR signature associated with the particular GNSS satellite;

(vii) in response to determining that the second broadcast matches the GNSS IR signature, update the GNSS IR signature in the memory at least in part using the second broadcast; and

(viii) in response to determining that the second broadcast does not match the GNSS IR signature, generate an alert indicating spoofing of the particular GNSS satellite.

The goal is to make an attack impossible or impractical, while characterizing and/or localizing the source of an attack. GNSS spoofing detection using GNSS-IR signatures improves upon existing GNSS receiver/antenna hardware, software and infrastructure (to include processing of real-time data streams) without requiring additional or new hardware. There is significant literature on the analysis and derivation of global navigation satellite system (GNSS) interferometric reflectometry (GNSS-IR) in remote sensing applications and multipath environment mapping [2]-[5]. GNSS-IR leverages time variant signal-to-noise ratio (SNR) measurements from GNSS receivers to derive estimates of ocean wave height, soil moisture content, snow depth, etc. These calculations involve the analysis of multipath propagation and direct line-of-sight (LOS) radio frequency (RF) transmissions from GNSS satellites.

As an example, a single L1 C/A code only multipathed signal (MP) and direct LOS signal (LOS) from the kth Global Positioning Satellite (GPS) can be represented by the following equation:

S_{L1}^{(k)}(t)=\sqrt{2P_{LOS}}·x^{(k)}(t)·D^{(k)}(t)·cos (2πf_{L1}t+θ_{LOS})+\sqrt{2P_{MP}}·y^{(k)}(t)·D^{(k)}(t)·cos (2πf_{L1}t+θ_{MP})

Where,

P=Signal Power,

x=Direct Sequence Spread Spectrum (DSSS) code/pseudo random noise (PRN) code,

t=time epoch,

D=Broadcast Navigation Message Data,

f=Carrier Frequency, GPS L1=1575.42 MHz, and

θ=Phase delay

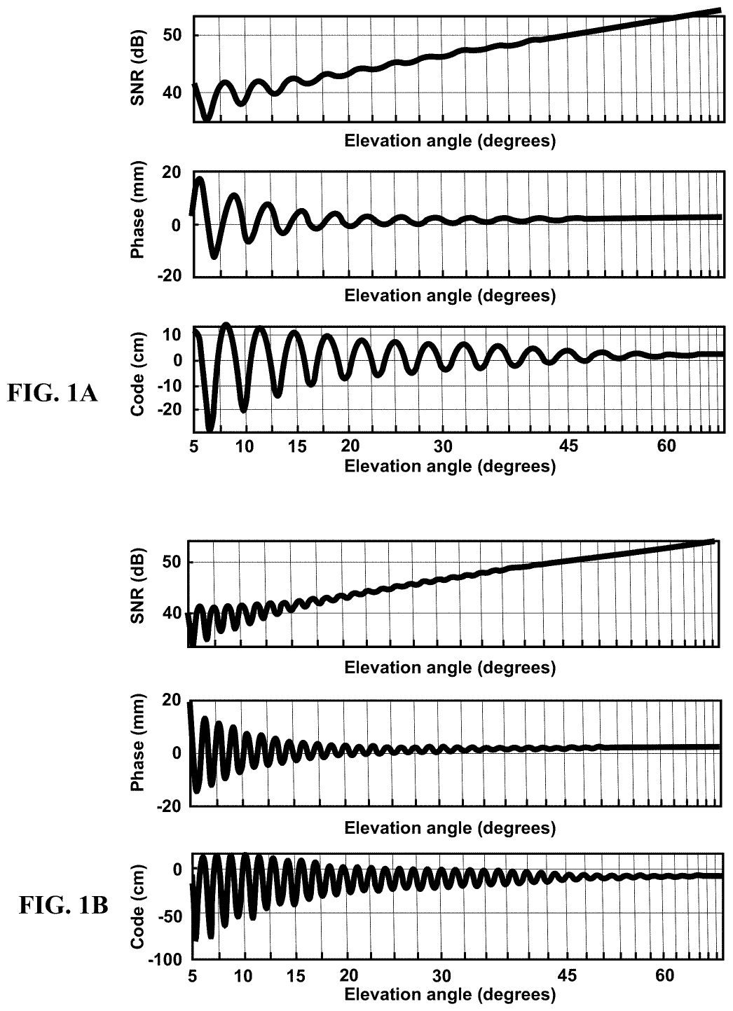

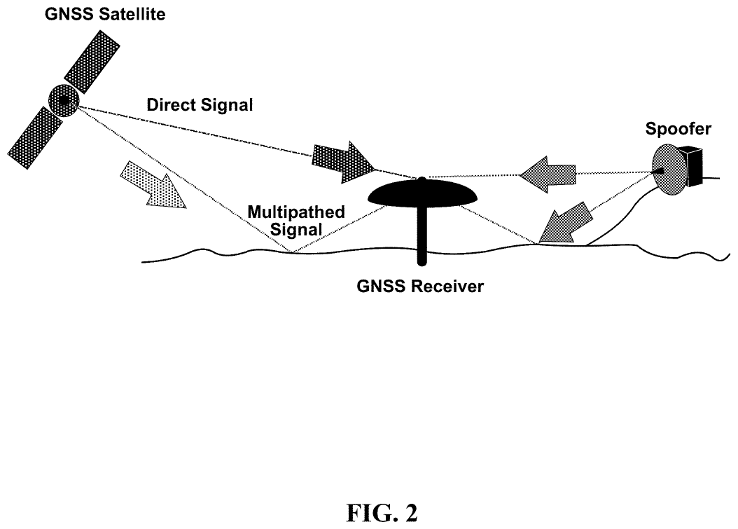

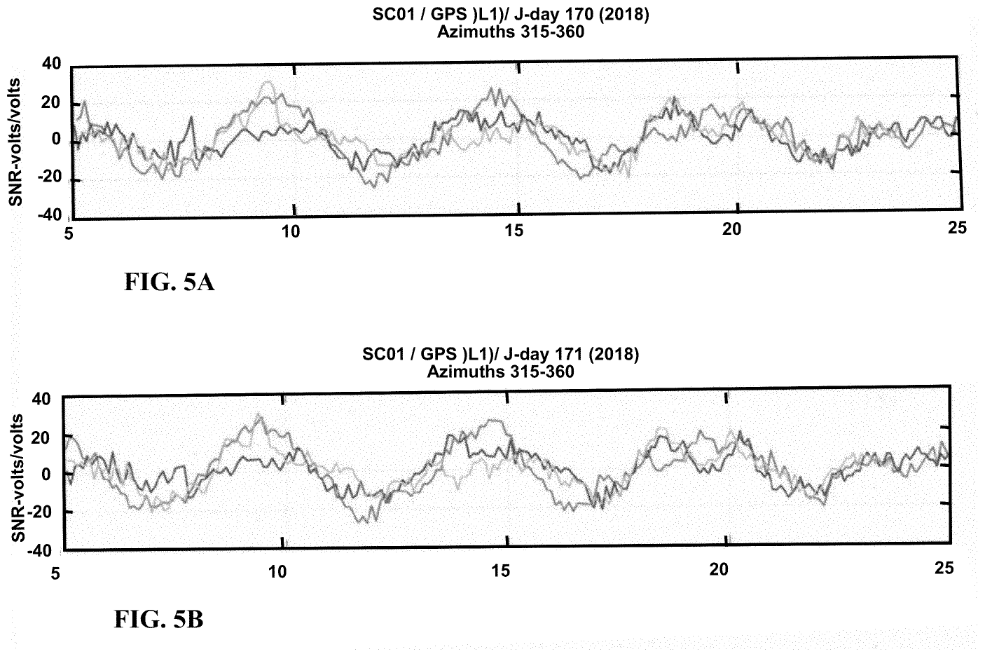

FIGS. 1A-2B are simulated impacts of multipath and LOS signals (GPS L2C) on SNR and Carrier and Code Phases vs. satellite elevation at fixed GNSS receivers that are 2 meters (FIG. 1A) and 5 meters (FIG. 1B) above a flat, specular reflective point. Notice the change in phases and frequencies of the oscillations.

FIG. 2 is an overview of GNSS Interferometric Reflectometry for Spoofing Detection.

Assuming a local level, planar reflective surface, the GNSS receiver signal-to-noise ratio (SNR) measurements of a multipathed GNSS satellite signal can be represented by the following equation [4]:

$$SNR ( e ) = A ( e ) sin ( \frac{4 π {H}_{R}}{λ} sin e + φ )$$

Where,

A is the amplitude,

H is the antenna phase center's height above the reflecting surface,

λ is the GNSS signal wavelength,

e is the satellite elevation above the local horizon, and

ϕ is the phase of the GNSS signal.

The reflected signals that are received by the GNSS antenna experience phase delay and attenuation. The multipathed signals and LOS signals from each tracked GNSS satellite impact the resultant SNR measurements post-autocorrelation function resulting in semi-sinusoidal oscillations with varying frequency and dampening rate of the SNR measurements. The resultant SNR measurements from the reflected signals are unique to both the relative position of each transmitting satellite and each receiving fixed GNSS reference station over time. In addition, the SNR is uniquely impacted in frequency, phase and signal power level by the local environment (see FIG. 1). The SNR measurements are also affected by the height of the GNSS receiver antenna, antenna design characteristics, and receiver noise (in addition to the relative elevation and azimuth of each tracked GNSS satellite). The uniqueness of each multipathed SNR measurement, or GNSS-IR signature, provides an elegant and novel mechanism to differentiate true, good GNSS satellite transmissions from spoofed GNSS signals from an attacker. SNR measurements also provide an indication of RFI [6]. Furthermore, GNSS-IR signatures from two or more GNSS receivers can be leveraged to further strengthen spoofing detection. It would require significant and highly-complex resources to generate the exact GNSS-IR signatures for each GNSS satellite at each fixed GNSS reference station.

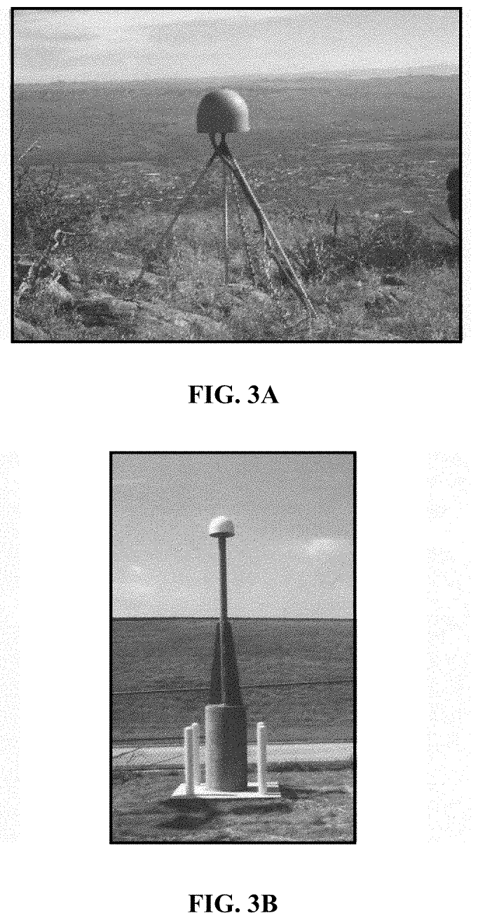

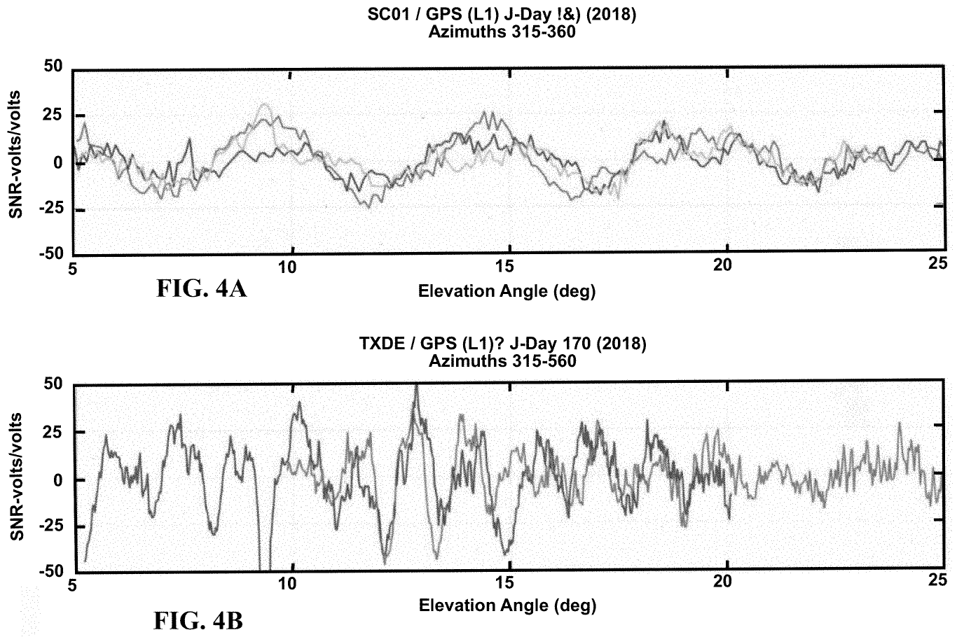

FIG. 3A is a view of Socorro, N. Mex. Reference Station Antenna looking south. FIG. 3B is a view of Denton, Tex. Reference Station Antenna looking North. The different antenna heights and environments (terrain, vegetation, etc.) causes unique signatures shown in FIGS. 4A-4B.

FIG. 4A is a graphical plot of GNSS-IR Signatures of GPS L1 transmission as measure by SC01 Reference Stations in Socorro, N. Mex. on June 19 (J-Day 170), 2018 from 0000-1200 UTC between 315 to 360 azimuths. FIG. 4B is a graphical plot of GNSS-IR Signatures of GPS L1 transmission as measure by TXDE Reference Station in Denton, Tex. on June 19 (J-Day 170), 2018 from 0000-1200 UTC between 315 to 360 azimuths. Notice how each reference station has a unique GNSS-IR signatures with different frequency, phase and SNR power levels for each tracked satellite.

FIGS. 5A 5B are a graphical plots of two-hour, truncated GNSS-IR Signatures at a fixed reference station (SCO1) in 2018 on J-Day 170 and J-Day 171 respectively showing strong cross-correlation between 3 GPS satellite SNR measurements across two days.

TEST RESULTS: On 20180625, demonstrated that GNSS-IR signatures are uniquely impacted by features within Fresnel zones, antenna height and receiver noise. Each signature is unique to each GNSS satellite-fixed reference station receiver/antenna pair further demonstrating the increased complexity of the attack surface and provides a novel method by which an authenticate GNSS signal can be distinguished from a false GNSS signal.

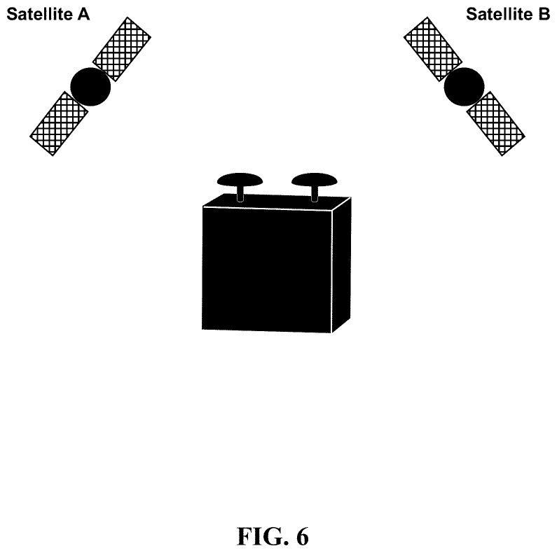

FIG. 6 is an example Dual-Antenna or Receiver configuration on building. Differing multipathed signals between each antenna-satellite pair produces unique GNSS-IR signatures.

### EXAMPLE

GNSS-IR signature produced from multipathed signal from satellite A to antenna A will not be the same as GNSS-IR signature produced from multipathed signal from satellite A to antenna B. This applies to every satellite being tracked at a given time, upwards of 10 GPS and more if multi-GNSS. A single spoofer would have to be able to generate SNR oscillations matching all unique signatures for both antennas for all tracked satellites at the same time and prevent each antenna from tracking the false signal(s) intended for the other antenna. This is quite a daunting, if not impossible, task. This diagram excludes direct LOS signals.

### Detailed Description of an Illustrative Embodiment

First, collect measurements from GNSS receiver. For example, The Global Positioning System (GPS) satellites each have an orbital period of approximately 11 hours 58 minutes, which causes each GPS satellite to repeat its ground trace approximately every 23 hours 56 minutes [8]. Therefore, since the azimuth and elevation of each GPS satellite local to the fixed receiver repeats, the multipathed signals will exhibited similar variations. The magnitude of these oscillation is greater at elevations of approximately <30 degrees. Therefore, GNSS-IR signatures used for initial calibration for GPS satellites should contain the following data during the rising and setting elevation (approximately <30°-400: SNR measurements and trusted broadcast satellite emphemeris or almanac from a trusted, authenticated source [these can be from the broadcast navigation message or another secure source such as Assisted GPS (A-GPS), Differential GPS (DGPS) or Real-time Kinematic (RTK) base stations]. GNSS-IR signature measurement can be collected for all GNSS signals and available codes (i.e. GPS L1 1575.42 MHz, L2C 1227.6 MHz, etc.).

In one or more embodiments, collect/apply in situ environmental monitoring data such as meteorological data to received measurements to improve signal and noise modeling. Collect/apply physical environment sensor data such as motion detectors, cameras to assess physical environment dynamics in the First Fresnel Zone (FFZ).

Second, calculate GNSS-IR signature (repeat for each tracked GNSS satellite) by: (i) deriving local Azimuth and Elevation from almanac or ephemerides; and (ii) reducing or normalizing SNR measurements. An example of reduction is as follows:

i. Convert to standard units and linear scale

1. Example: dB-Hz converted to volts/volts (See FIG. 6)

ii. Remove dominant direct signal contributions

1. Example: Subtract a low-order polynomial fit curve of the binned azimuths of SNR measurements as a function of elevation angle from the measurements. (See FIG. 6)

Third, store as GNSS-IR signature for satellite as azimuth, elevation, calibration fit curve and SNR measurements.

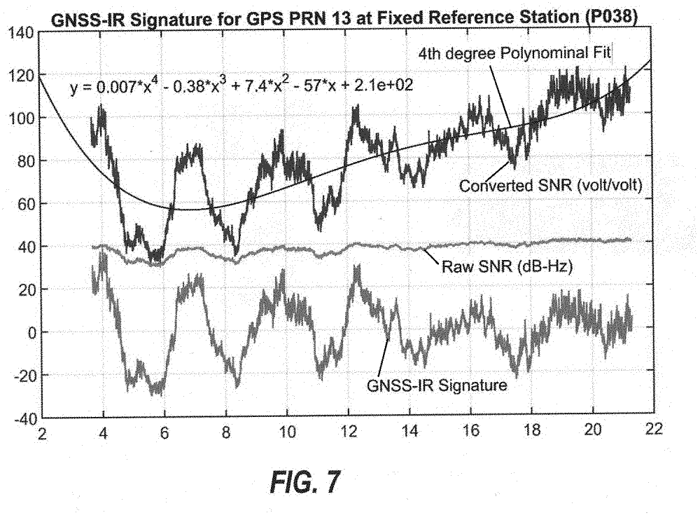

Fourth, collect/monitor new measurements for spoofing detection (See FIG. 7):

a. Convert to standard units and linear scale
b. Remove direct line of sight GNSS measurements

i. Subtract low-order polynomial fit curve derived from 2b (truth source estimate)

c. Calculate correlation between truth GNSS-IR signature and new GNSS-IR signature (derived from new measurements)
d. Optional: implement multi-state Extended Kalman Filter and monitor residuals or use extended signal and noise models for receiver, antenna, ray tracing, physical optics.

Fifth, determine if new GNSS-IR signature is outside acceptable covariance bounds:

a. Yes: Alert

i. When alert cleared, retain starting GNSS-IR signature and open covariance bounds until new signature obtained, return to step 4

b. No: Store new GNSS-IR signature, return to step 4

FIG. 7 is a graphical plot 700 of a six-hour GNSS-IR Signature showing each processing step: (1) Collect Raw SNR Measurements; (2) Convert to volt/volt; and (3) remove low-order polynomial.

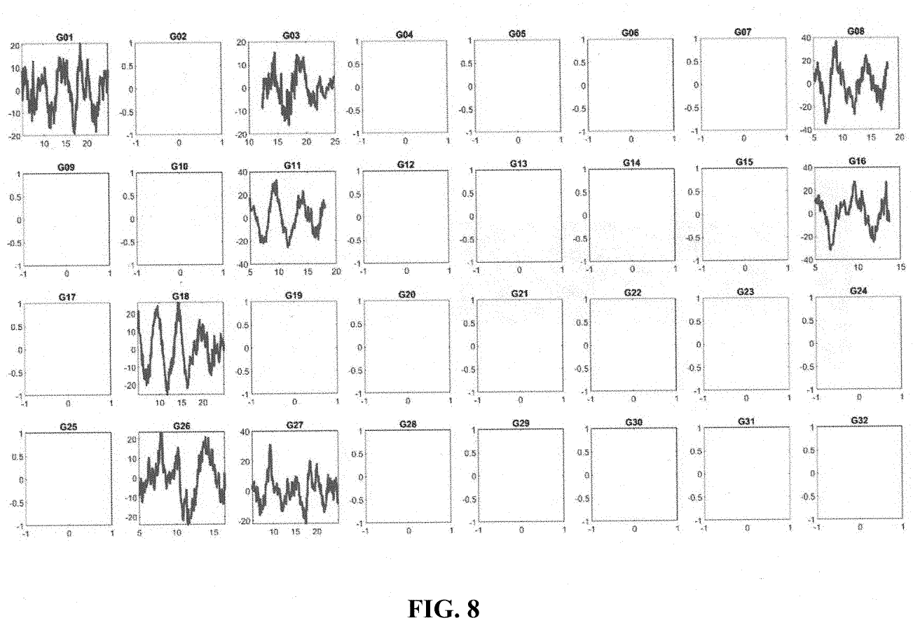

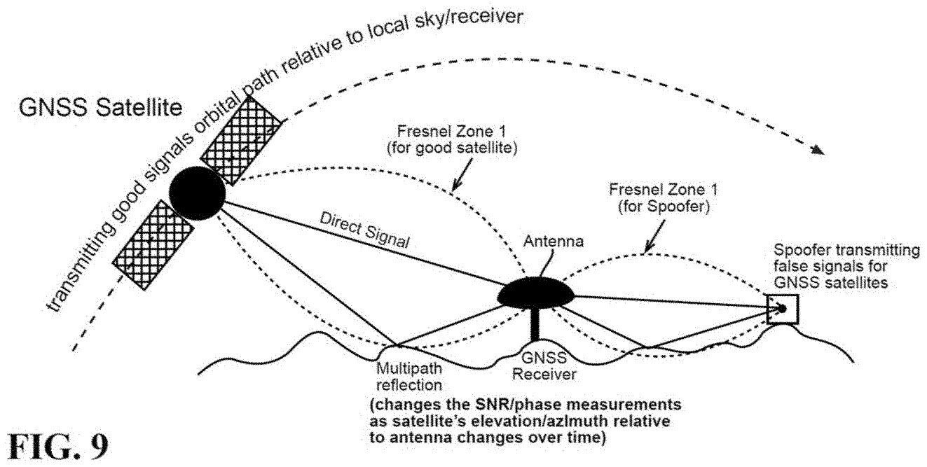

FIG. 8 is user interface depiction 800 of a GNSS-IR Signature Monitoring Tool for GPS satellites written in MATLAB by Steven Lewis, Univ. of Colorado Colorado Springs.

The proposed method involves the following considerations:

1. The Environment Local to the receiver antenna:

a. The area within the first Fresnel (reflection) Zone with respect to physical structures, reflective and dispersive surfaces should be relatively stable or properly modeled. The area of the first Fresnel Zone changes with the satellite elevation and antenna height. For a 2-meter height antenna and only using satellite elevation angles less than 30 degrees the first Fresnel Zone is less than 50 meters.

b. In order to account or more accurately model significant changes in water levels (vapor, snow or ice, rain, etc.) in the local environment, it is highly desired to use in situ metrological data (meteorological or met data such as provided by RINEX and other GNSS data types).

### 2. The GNSS Reference Station Configuration

a. In order to provide the maximum multipath-based mapping for GNSS-IR signatures, the GNSS receiver should be configured to track at a minimum all healthy GPS satellites with no elevation mask angle

b. The GNSS reference station should have a stable hardware configuration, to include antenna, cabling, receiver and, if used, metrological sensors.

### 3. The GNSS Satellites

a. For GPS-IR signature-based spoofing defense, must use GPS measurement to detect GPS spoofing, GLONASS/GLONASS, Galileo/Galileo, etc.

b. Must not include unhealthy satellites; satellites that have been turned off to users based on the broadcast navigation message health bits

### 4. Calibration/Re-Calibration

a. Each Fixed Reference station requires as initial calibration/normalization to establish initial mapping of GNSS-IR signatures

b. A re-calibration may be necessary for any configuration or other changes such as the following: (i) Environment: heavy construction, unusually significant activity; (ii) Fixed GNSS Reference Station maintenance; (iii) GNSS Satellites (orbital maneuver, maintenance, new satellite); (iv) Alarm condition from detected attack event (RFI, spoofing, etc).

c. Each 24-hour period, a new calibration signature should be derived and should significantly reduce or eliminate slow-dynamic environmental changes such as vegetation.

Overview of Claims:

1. A method to detect GNSS Spoofing:

a. Using measurements of multipath propagation reflections from GNSS satellites to generate unique GNSS-IR signatures.

2. An algorithm to generate a GNSS-IR Signature:

a. Collect GNSS SNR and phase measurements;

b. Convert to standard scale and units;

c. Remove direct line of sight GNSS measurements;

d. Collect multipathed GNSS signal measurements from previous; and

e. Store resultant GNSS-IR signature.

3. An algorithm to detect GNSS Spoofing from GNSS-IR Signature variance:

a. Collect GNSS SNR and phase measurements;

b. Covert to standard scale and units;

c. Remove dominant direct line of sight GNSS measurements using truth-source estimates and/or measurements;

d. Collect multipathed GNSS signal measurements from previous;

e. Correlate truth GNSS-IR signature from new GNSS-IR signature;

f. Determine if outside established covariance limits; and

g. Alert as required.

4. A method of operating a GNSS receiver:

a. Fixed receiver with physical environment within Fresnel Zone 1 with short-term stability;

b. Dual-antenna configuration with adequate separation and/or orientation to yield unique GNSS-IR signatures for each satellite-to-receiver pair; and

c. Dual receiver configuration with adequate separation and/or orientation to yield unique GNSS-IR signatures for each satellite-to-receiver pair.

5. A method in claim 3 further comprising:

a. Calibration/Recalibration methods

Works Cited above and hereby incorporated by reference in their entirety:
[1] M. L. Psiaki and T. E. Humphreys, “GNSS Spoofing and Detection,” Proc. IEEE, vol. 104, no. 6, pp. 1258-1270, June 2016.
[2] A. Bilich and K. M. Larson, “Mapping the GPS multipath environment using the signal-to-noise ratio (SNR),” Radio Sci., vol. 42, no. 6, pp. 1-16, 2007.
[3] P. Axelrad, K. M. Larson, and B. Jones, “Use of the correct satellite repeat period to characterize and reduce site-specific multipath errors,” ION GNSS 18th Int. Tech. Meet. Satell. Div., no. September, pp. 2638-2648, 2005.
[4] C. Roesler and K. M. Larson, “Software tools for GNSS interferometric reflectometry(GNSS-IR),” GPS Solut., vol. 0, no. 0, p. 0, 2018.
[5] K. M. Larson and E. E. Small, “Estimation of Snow Depth Using L1 GPS Signal-to-Noise Ratio Data,” IEEE J. Sel. Top. Appl. Earth Obs. Remote Sens., vol. 9, no. 10, pp. 4802-4808, 2016.
[6] S. Lewis, L. Maynard, E. Chow, and D. Akos, “Secure GPS Data for Critical Infrastructure and Key Resources: Cross Layered Integrity Processing and Alerting Service,” Navig. J. Inst. Navig., 2018.
[7] D. M. Akos, “Who's Afraid of the Spoofer? GPS/GNSS Spoofing Detection via Automatic Gain Control (AGC),” Navigation, vol. 59, no. 4, pp. 281-290, December 2012.
[8] P. Axelrad and K. Larson, “GNSS Solutions: Orbital precession, optimal dual-frequency techniques, and Galileo receivers,” Insid. GNSS, no. July/August 2006, pp. 16-17, 2006.
[9] AF IMT 1279, 8. Invention use: a single test case using a representative, fixed attacker (WAAS satellite) broadcasting on GPS 11 1575.42 MHz was conducted on 13 Jan. 2019.

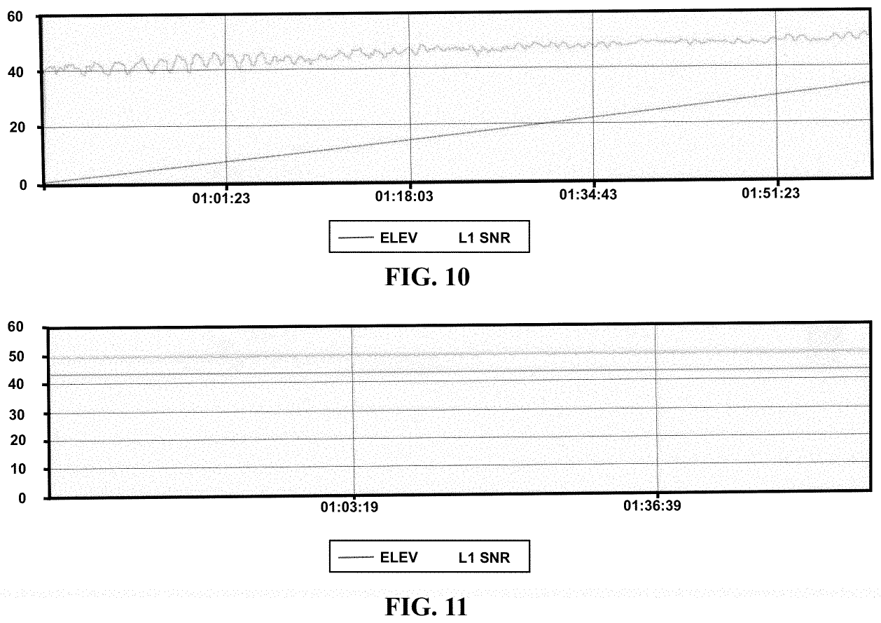

FIG. 10 is a graphical plot 1000 of GNSS-IR Signature from GPS PRN-17 at FAA CORS in Longmont, Colo.

FIG. 11 is a graphical plot 1100 of GNSS-IR Signature from Fixed Transmitter at approx. 44 degrees local elevation (WAAS-138 on GPS L1) to FAA CORS in Longmont, Colo., which is the same site & date/time as FIG. 10.

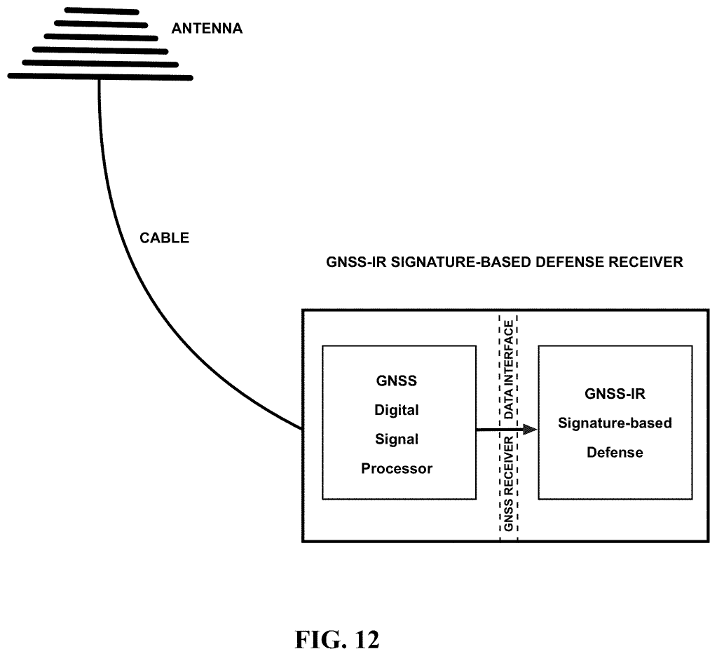

FIG. 12 is a diagram of a GNS-IR signature-based defense receiver 1200.

### Summary

GNSS spoofing detection using GNSS-IR signatures can utilize all fixed GNSS receivers that are capable of providing SNR measurements. This method can also use each satellites' time-dependent azimuth and elevation to the receiver to generate GNSS-IR signatures (i.e. calculated from precise ephemerides, A-GPS, broadcast almanac/navigation message, etc.) A GNSS-IR signature consists of the complete or equivalent removal of the dominant direct LOS GNSS signal SNR (or phase measurements) from the GNSS receiver SNR (or phase) measurements. Each signature is specific in time to the measurement made between a distinct, single GNSS receiver/antenna and GNSS satellite pair.

To improve detection capability, GNSS receivers with dual-antenna capability, or an additional GNSS receiver and antenna can be used. Each antenna should be installed in a stable, but unique environment, especially within the first Fresnel (reflection) Zone. Since a Fresnel Zone is described by a three-dimensional, cylindrical ellipse between a transmitter (GNSS satellite) and the receiver, it will change where it intersects the local environment (i.e. ground, objects, etc) over time as the satellite changes local elevation and azimuth as it orbits Earth [4]. A good example would be to install one antenna on one edge of a building and a second antenna installed on the same building, but on the opposite edge (See FIG. 5). This would ensure that the GNSS-IR signatures produced by each receiver-satellite pair are distinct and uncorrelated. This would require an attacker to modulate spoofed signals for the same GNSS satellite(s) but with different phase or SNR oscillations that match the GNSS-IR signatures from both receivers at the same time. Furthermore, there is low probability that each spoofed signal only reaches the single target receiver. The attacker's multipathed signal(s) would have to match all GNSS satellite vehicles that are being monitored with GNSS-IR spoofing detection signatures. Due to the actual GNSS satellite elevation/azimuth and spatial diversity relative to each GNSS receiver, this could not easily be accomplished by a single spoofing device. A single spoofer would transmit false signals from one location, thus producing its own unique multipathed signature different from the GNSS-IR signatures derived from the true GNSS satellites.

The SNR measurements used for GNSS-IR signatures can also be used for RFI detection. Additional measurements from a GNSS receiver's automatic gain control (AGC) component, also readily available from existing GNSS receivers, can be leveraged to distinguish between RFI sources and GNSS satellite signal losses or attenuation caused by physical occlusions such as a bird landing on the antenna [6], [7].

Additional information is provided in an article by the inventor that is incorporated by reference in its entirety and previously published not earlier than 21 Aug. 2018 as: “Secure GPS Data for Critical Infrastructure and Key Resources: Cross-Layered Integrity Processing and Alerting Service”, Navigation, Ion Institute of Navigation, Volume 65, Issue 3, Autumn (Fall) 2018, pp. 389-403.

Additional information is provided in a 2019 dissertation by the inventor and entitled “Defending Against Radio Frequency Spoofing Attacks on Fixed Global Navigation Satellite System Receivers Using Interferometric Reflectometry Signatures”, that is incorporated by reference in its entirety.

Additional information is provided in Appendix 3 to the above referenced most recent priority document, which is a 2019 article submitted for publication by the inventor and entitled “GNSS Interferometric Reflectometry Signature-based Defense”, that is incorporated by reference in its entirety. In particular, the following aspects of the present disclosure are described:

GNSS signals are vulnerable to RFI and spoofing. There are several documented GNSS RFI and spoofing detection methods. RFI detection has become trivial with many detection algorithms available and built into GNSS receivers. This is not the case with spoofing. GNSS spoofing can involve generating false GNSS signal with one of more altered components of GNSS satellite transmissions: RF carrier, pseudorandom noise codes, and/or the broadcast navigation messages. Like jamming, generating spoofed GNSS signals is becoming easier and can have disastrous effects on people and systems, such as critical infrastructure and key resources (CIKR), which rely on GNSS for positioning, navigation and timing (PNT).

GNSS interferometric reflectometry (GNSS-IR) signature-based defense is a new methodology to defend wireless space-based PNT transmissions against spoofing by leveraging existing, fixed GNSS receivers used in GNSS-dependent critical infrastructure and key resource sectors. GNSS-IR signature-enabled defense provides spoofing and RFI detection without any changes to existing architecture by conducting input validation of standard GNSS receiver observables against a generated GNSS-IR truth calibration signature. This paper includes an overview of the theory, methodology and results of live-sky signature variability experiments.

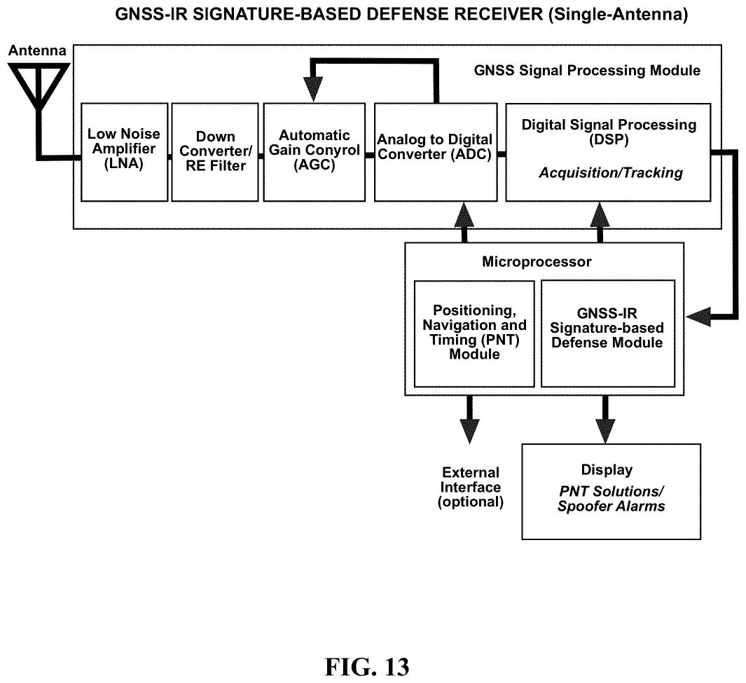

FIG. 13 is a block diagram of a GNS-IR signature-based defense receiver with a single antenna. A system or apparatus detects whether a fixed, stationary GNSS receiver is being spoofed. The system includes: (i) a GNSS antenna configured to receive and efficiently amplify GNSS frequencies; (ii) a GNSS antenna with or without multipath mitigation technologies such as choke rings; (iii) a GNSS signal processing module that provides sufficient signal amplification, down-conversion to an intermediate frequency, radio frequency filtering, analog to digital conversion and acquisition and tracking of GNSS signals to be protected; (iv) a Microprocessor that contains a Positioning, Navigation and Timing (PNT) Module to compute PNT solutions from GNSS Signal Processing Module observables received over a system bus; (v) a Microprocessor that contains a GNSS-IR Signature-based Defense Module to generate calibration signatures, perform input validation providing spoofing detection and driving warning, alert and alarm functions; (vi) a Display for displaying PNT solutions and spoofer alarms; and (vii) an optional External Interface to provide spoofing alarms to a remote, regional alarm monitoring system.

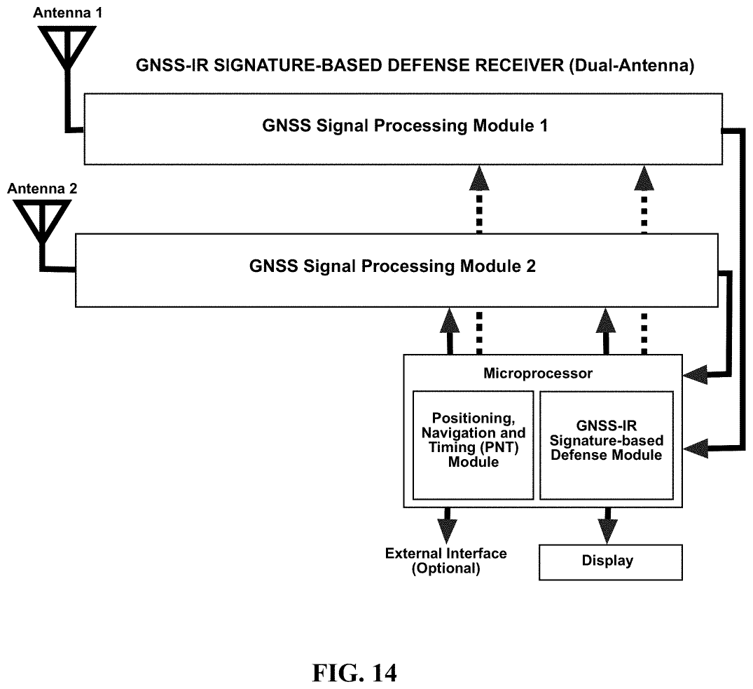

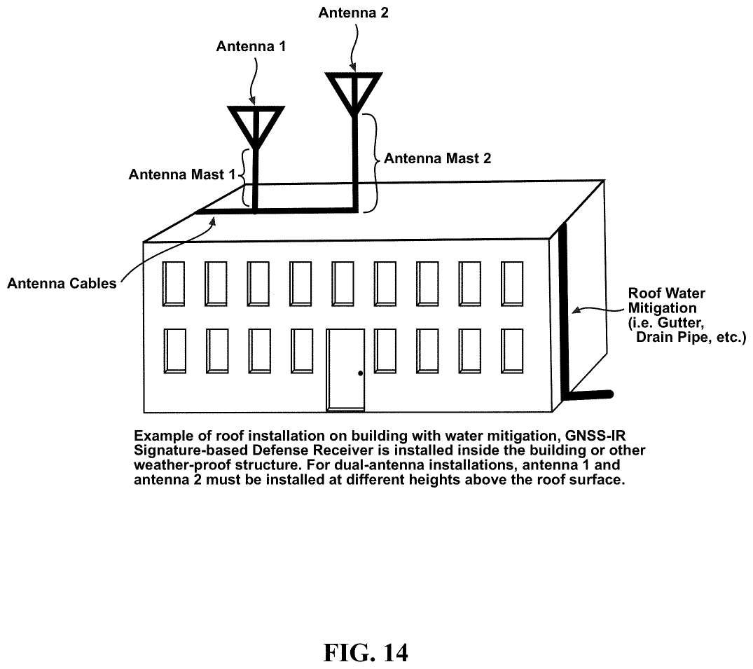

FIG. 14 is a block diagram of a GNS-IR signature-based defense receiver with dual antennas. For dual-antenna configuration, GNSS antennas are mounted on antenna masts that yield different heights above the contributing reflective surfaces. In one or more embodiments, a dual-antenna system consists of dual antennas of different heights above the reflectors and dual GNSS Signal Processing Modules.

FIG. 15 is a three-dimensional view of a building 1500 have dual mast antennas 1502, 1504 of differing heights mounted for GNS-IR signature-based defense receiving. Roof 1506 is drained to reflective effects of pooled water.

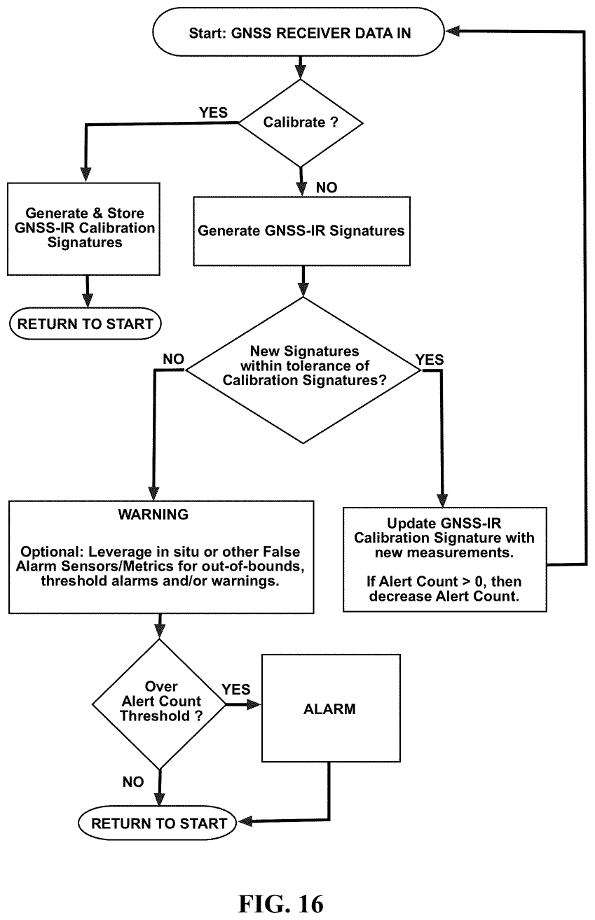

FIG. 16 is a flow diagram illustrating a method of GNSS spoofing detection using GNSS-IR signatures. According to one or more embodiments, the method 1600 is for detecting if a fixed, stationary global navigation satellite system (GNSS) receiver is being spoofed. The method 1600 includes using direct line-of-sight and reflected radio frequency signal strength measurements from received GNSS satellite broadcasts. The method 1600 includes smoothing the signal strength measurements for each unique satellite pass using a method such as a moving-average smoother, and stored in memory as calibration signatures. The method 1600 includes using a smoother, such as a moving-average smoother, to deal with spurious noise in the GNSS signal power measurements. In one or more embodiments, the method 1600 includes, for the single-antenna GNSS-IR Signature-based Defense receiver, creating calibration signatures using an additional 5-day rolling window smoother to generate initial and recalibration signatures. Following collection, processing and storage of GNSS constellation calibration signatures, the method 1600 includes performing input validation on new signal strength measurements or observations using the calibration signatures. For example, method 1600 can includes using a detector algorithm for input validation resulting in the difference between the square of the calibration signature and square of the new observations for a specific satellite at a specific altitude above the local horizon normalized by the square of the calibration signature. Method 1600 includes a binary hypothesis evaluation function to set a detection threshold using a likelihood cost function minimum for unspoofed and spoofed conditions to meet a predetermined false alarm rate. Method 1600 includes determining that the GNSS signals are being spoofed if the spoofing detection hypothesis test statistic is greater than the predetermined threshold. Spoofing indications drive a warning function that provides alerts and alarms to a display.

In one or more embodiments, method 1600 further includes determining whether the residuals of the input validation detector are above a threshold due to substantially different GNSS signal strength measurements.

In one or more embodiments, method 1600 further includes that calibration signatures are generated for a single-antenna configuration using 5-day moving-windowed signatures comprised of GNSS signal strength measurements from rise to set above the local horizon of the antenna in which there is a unique, repeating groundtrace. Using a 5-day moving-widow of signatures provides calibration signature smoothing for changes on the contributing reflective surfaces from rain or snow to avoid false alarms. Using a roof installation with water mitigation, such as gutters or drains, avoids pooling water on contributing reflective surfaces.

In one or more embodiments, method 1600 further includes generating calibration signatures for a dual-antenna configuration using smoothed GNSS signal strength measurements from the first full pass, rise to set above the local horizon of the antennas.

In one or more embodiments, method 1600 further includes using dual-antennas of differing heights above the local reflective surfaces within the contributing Fresnel zones that are used to detect a GNSS spoofer without concern for contributing reflective surface dielectric property changes such as rain or snow.

In the preceding detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A method for authenticating a global navigation satellite system (GNSS) signal, the method comprising:
receiving, by a fixed, stationary GNSS receiver at a geographic location, a first broadcast from a particular GNSS satellite during a particular earth orbit;
determining identifying information for the particular GNSS satellite according to GNSS satellite communication protocols;
measuring line of sight and reflected signal strengths of the first broadcast of the particular GNSS satellite during a portion of the particular earth orbit to detect multipath variations that are characteristic for the geographic location;
creating a GNSS interferometric reflectometry (IR) signatures associated with the particular GNSS satellite based on the measured broadcast;
during a subsequent earth orbit, determining whether a second broadcast self-identified as being from the particular GNSS satellite matches the GNSS IR signature associated with the particular GNSS satellite;
in response to determining that the second broadcast matches the GNSS IR signature, updating the GNSS IR signature at least in part using the second broadcast; and
in response to determining that the second broadcast does not match the GNSS IR signature, generating an alert indicating spoofing of the particular GNSS satellite.

2. The method of claim 1, wherein creating the GNSS IF signatures comprises combining results of multiple broadcasts including the first broadcast using a moving average smoothing algorithm to mitigate spurious noise in the respective broadcasts.

3. The method of claim 1, wherein receiving the first broadcast and the second broadcast comprises using two antennas positioned at the geographic location on masts of different heights to mitigate reflective effects of precipitation on a surrounding area.

4. The method of claim 1, wherein:
receiving the first broadcast and the second broadcast comprises using one antenna positioned at the geographic location having a surrounding area that prevents accumulation of pooling water that acts as a contributing reflective surface; and
adjusting the measurements of a particular broadcast to compensate for predetermined reflective effects of one of rain and snow on the surrounding area.

5. The method of claim 1, wherein determining whether the second broadcast matches the first broadcast comprises using a validation detector algorithm that results in a difference between square of the GNSS IR signature and a square of the measurement of the second broadcast both as a function of a specific altitude of the particular GNSS satellite above a local horizon normalized by the square of the GNSS IR signature.

6. The method of claim 1, wherein determining that the second broadcast matches the GNSS IR signature comprises using a binary hypothesis evaluation function to set a detection threshold using a likelihood cost function minimum for unspoofed and spoofed conditions to meet a predetermined false alarm rate.

7. The method of claim 6, wherein determining that the second broadcast matches the GNSS IR signature comprises determining whether a spoofing detection hypothesis test statistic is greater than the detection threshold.

8. A global navigation satellite system (GNSS) interferometric reflectometry (IR) signature-based defense system comprising:
a first GNSS antenna mounted on a first antenna mast at a geographic location;
a first GNSS receiver that is communicatively coupled to the at least one GNSS antenna;
a memory containing: (i) a positioning, navigation and timing (PNT) module; and (ii) a GNSS-IR signature-based defense module;
a controller communicatively coupled to the first receiver and the memory, the controller executing the PNT module and the GNSS-IR signature-based defense module to enable the GNSS-IR signature based defense system to:
receive, the GNSS receiver, a first broadcast from a particular GNSS satellite during a particular earth orbit;
determine identifying information for the particular GNSS satellite according to GNSS satellite communication protocols;
measure line of sight and reflected signal strengths of the first broadcast of the particular GNSS satellite during a portion of the particular earth orbit to detect multipath variations that are characteristic for the geographic location;
create a GNSS IR signatures associated with the particular GNSS satellite based on the measured broadcast;
store the GNSS-IR signature in the memory;
during a subsequent earth orbit, determine whether a second broadcast self-identified as being from the particular GNSS satellite matches the GNSS IR signature associated with the particular GNSS satellite; and
in response to determining that the second broadcast matches the GNSS IR signature, update the GNSS IR signature in the memory at least in part using the second broadcast; and
in response to determining that the second broadcast does not match the GNSS IR signature, generate an alert indicating spoofing of the particular GNSS satellite.

9. The GNSS IR signature-based defense system of claim 8, wherein the controller executes the PNT module to enable the GNSS-IR signature based defense system to create the GNSS IF signatures by combining results of multiple broadcasts including the first broadcast using a moving average smoothing algorithm to mitigate spurious noise in the respective broadcasts.

10. The GNSS IR signature-based defense system of claim 8, wherein the controller executes the PNT module to enable the GNSS-IR signature based defense system to:
receive the first broadcast and the second broadcast comprises using one antenna positioned at the geographic location having a surrounding area that prevents accumulation of pooling water that acts as a contributing reflective surface; and
adjust the measurements of a particular broadcast to compensate for predetermined reflective effects of one of rain and snow on the surrounding area.

11. The GNSS IR signature-based defense system of claim 8, further comprising:
a second GNSS antenna mounted on a second antenna mast at the geographic location, the second antenna mast having a different height than the first antenna mast; and
a second GNSS receiver that is communicatively coupled to the at least one GNSS antenna, wherein the controller is communicatively coupled to the second receiver, the controller executes the PNT module and the GNSS-IR signature-based defense module to enable the GNSS-IR signature based defense system to use the first and second antennas positioned at the geographic location on the first and second antenna masts of different heights to mitigate reflective effects of precipitation on a surrounding area.

12. The GNSS IR signature-based defense system of claim 8, wherein the controller executes the GNSS-IR signature-based defense module to enable the GNSS-IR signature based defense system to determine whether the second broadcast matches the first broadcast comprises using a validation detector algorithm that results in a difference between square of the GNSS IR signature and a square of the measurement of the second broadcast both as a function of a specific altitude of the particular GNSS satellite above a local horizon normalized by the square of the GNSS IR signature.

13. The GNSS IR signature-based defense system of claim 8, wherein the controller executes the GNSS-IR signature-based defense module to determine that the second broadcast matches the GNSS IR signature by using a binary hypothesis evaluation function to set a detection threshold using a likelihood cost function minimum for unspoofed and spoofed conditions to meet a predetermined false alarm rate.

14. The GNSS IR signature-based defense system of claim 8, wherein the controller executes the GNSS-IR signature-based defense module to determine that the second broadcast matches the GNSS IR signature by determining whether a spoofing detection hypothesis test statistic is greater than the detection threshold.
